(19) United States
(12) Patent Application Publication
(10) Pub. No.: US 2016/0339830 A1
(43) Pub. Date: Nov. 24, 2016

(54) Strap-Winding Apparatus

(71) Applicant: Eric M. McLemore, Decatur, AL (US)

(72) Inventor: Eric M. McLemore, Decatur, AL (US)

(21) Appl. No.: 14/716,393

(22) Filed: May 19, 2015

(51) Int. Cl. B60P 7/08; B65H 75/44

(52) U.S. Cl. CPC B60P 7/0846; B60P 7/0838; B65H 75/446; B65H 75/4486

(57) ABSTRACT

A strap-winding apparatus of the present disclosure has a coupling member fixedly coupled to a frame and adapted for coupling to a stationary object. The strap-winding apparatus further has a winding device fixedly coupled to the frame and comprising a sleeve, the sleeve adapted for rotatably receiving and retaining a drill bit on a first end and a winding fork on a second end.

### BACKGROUND

Typically, trucks move cargo from one place to another on a truck flat bed or within enclosed cargo space of a semi-trailer. In moving cargo, whether on the flat bed or in the enclosed container, it is oftentimes advantageous to secure the cargo to eliminate movement of the cargo while in transit.

One widely used method of securing cargo in transit is via use of cargo straps. A cargo strap may be secured on one end to the truck, extended over the cargo, and secured on the other end to the truck. The strapping down of cargo ensures that the cargo does not move during transit. The cargo straps are typically fairly long in length so that they can perform their intended purpose, i.e., strapping down cargo.

Once the cargo arrives at its destination, the cargo straps are removed prior to unloading the cargo. The cargo straps are then stored for reuse on another load. Because of the length of the straps, it is cumbersome to roll up, store, and transport the cargo straps to pick up another load of cargo. Notably, oftentimes truckers manually roll up the cargo straps for storage after use until they are again needed for strapping down cargo.

### SUMMARY

A strap-winding apparatus of the present disclosure comprises a coupling member fixedly coupled to a frame and adapted for coupling to a stationary object. The strap-winding apparatus further comprises a winding device fixedly coupled to the frame and comprising a sleeve, the sleeve adapted for rotatably receiving and retaining a drill bit on a first end and a winding fork on a second end.

### BRIEF DESCRIPTION OF THE DRAWINGS

The various embodiments of the present disclosure are best understood by referring to FIGS. 1 through 6 of the drawings. The elements of the drawings are not necessarily to scale, emphasis instead being placed upon clearly illustrating the principles of the disclosure. Throughout the drawings, like numerals are used for like and corresponding parts of the various drawings.

FIG. 1 is a perspective view of a strap-winding apparatus in accordance with an embodiment of the present disclosure.

FIG. 2A is a perspective view of the strap-winding apparatus of FIG. 1 wherein a drill is used to wind a strap.

FIG. 2B is a perspective view of the strap-winding apparatus of FIG. 1 wherein the strap has been substantially wound for storage.

FIG. 3 is a perspective view of the strap-winding apparatus of FIG. 1 wherein a crank handle is used to wind a strap.

FIG. 4 is a side view of a portion of the strap-winding apparatus of FIG. 1 showing the coupling of the apparatus to a side of a vehicle.

FIG. 5 is a side view of the portion of the strap-winding apparatus of FIG. 5 showing a handle for coupling the strap-winding apparatus to the side of the vehicle.

### DETAILED DESCRIPTION

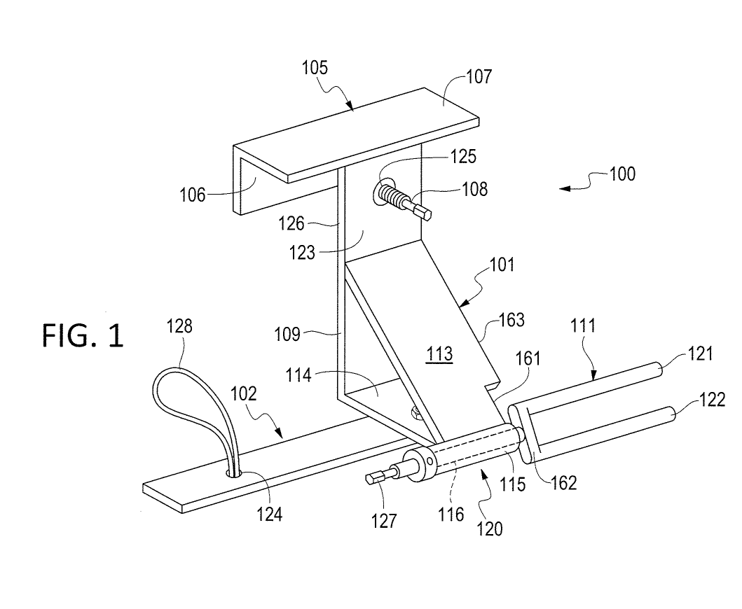

FIG. 1 depicts an exemplary embodiment of a strap-winding apparatus 100 in accordance with an embodiment of the present disclosure. The strap-winding apparatus 100 comprises a triangular frame 101, a retaining shelf 102, an L-shaped coupling member 105, and a winding device 120.

In one embodiment, each or some of the triangular frame 101, retaining shelf 102, L-shaped coupling member 105, and winding device 120 are fixedly and integrally formed into a unitary piece, for example via welding, so as to form a single unitary strap-winding apparatus 100. In another embodiment, each or some of the triangular frame 101, retaining shelf 102, L-shaped coupling member 105, and winding device 120 are separable components that are coupled, for example via bolts or the like.

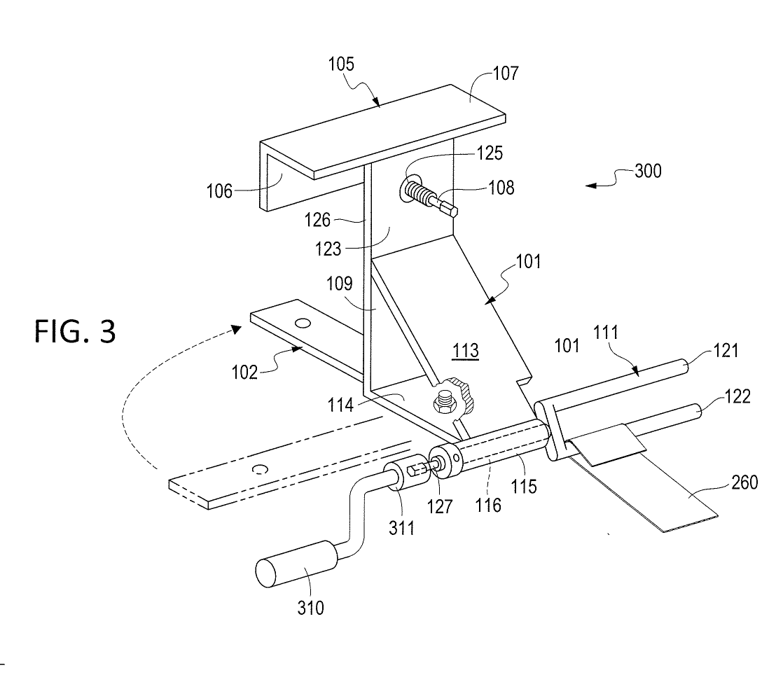

Notably, in the embodiment shown in FIG. 1, the retaining shelf 102 is moveably coupled to the triangular frame 101 via a bolt 101. As will be further described with reference to FIG. 3, the retaining shelf 102 may be rotated to a position such that a crank handle (not shown) may be used to rotate the winding device 120.

The triangular frame 101 comprises three sides, including a hypotenuse member 113, a side 109, and aside 114. Note that in the embodiment shown, the triangular frame 113 is a right triangle; however, other types of triangles and other shapes are possible in other embodiments. In this regard, the triangular frame 101 may be square or rectangular shaped in other embodiments.

The side 109 of the triangular frame 113 comprises an extension arm 126 that extends beyond the edge formed between the side 109 and the hypotenuse member 113. The extension arm 126 comprises a face 123, which is described further herein.

The L-shaped coupling member 105 is coupled to the extension arm 126 and is adapted and arranged for coupling the strap-winding apparatus 100 to a stationary object, for example a wall (not shown) of a bed (not shown) of a truck (not shown). The L-shaped coupling member 105 comprises a horizontal plate 107 and a vertical plate 106. The horizontal plate 107 and vertical plate 106 are integrally formed to create the L-shaped coupling member 105. As will be described further herein, in use the vertical plate 106 is inserted behind a vertically extending section of a truck side wall so that the strap-winding apparatus 100 may be coupled to the truck side wall. Note that the L-shaped coupling member 105 is exemplary, and other types of coupling members may be used in other embodiments.

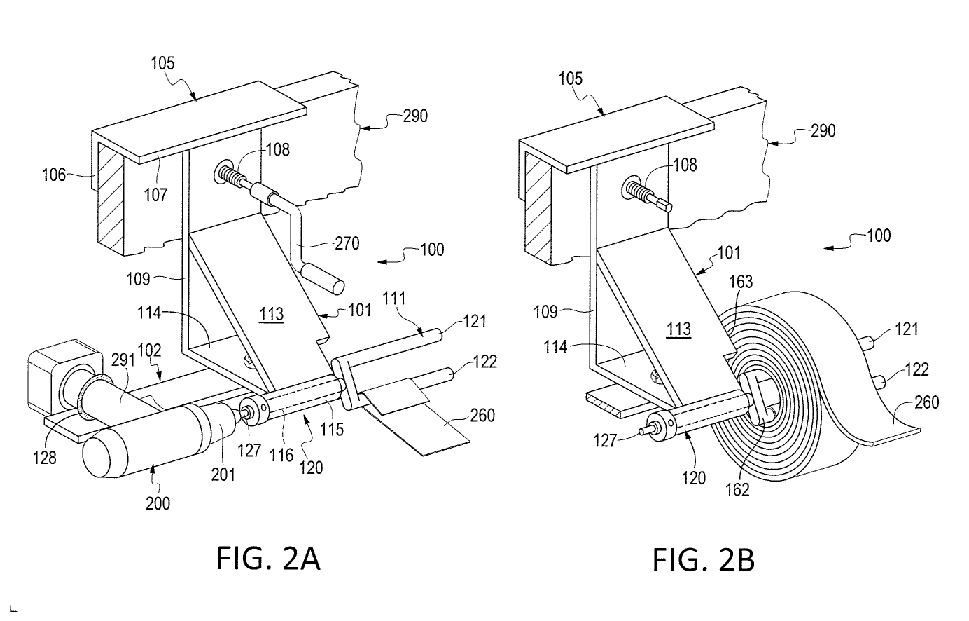

Through the face 123 of the extension arm 126 is a bore 125. Within the bore 125 a drill bit rod 108 is inserted, which is threadedly coupled to the bore 125. The drill bit rod 108 comprises a drill bit member 130 for attaching to a crank handle (not shown) described further herein. Once the vertical member 106 is installed adjacent to and behind a side wall of a bed of a truck (not shown but described in FIG. 2), the drill bit 108 is rotated, which causes the strap-winding apparatus 100 to be coupled to the side of the truck.

Additionally, the retaining shelf 102 extends from the side 114 of the triangular frame 101. Note that the retaining shelf 102 may be integrally formed with side 114 via welding. In another embodiment, the retaining shelf 102 may be removeably coupled to the side 114 with a fastener, e.g., a bolt.

The retaining shelf 102 comprises a bore 124 through which a coupling strap 128 extends. In one embodiment, the strap 128 is composed of an elastic material adapted and arranged to retain a drill (not shown), which is described further herein. The strap 128 is stretched around the drill to retain the drill in position. The drill in use in conjunction with the strap-winding apparatus 100 is shown in detail with reference to FIG. 2.

The winding device 120 comprises a sleeve 115, which is coupled to the intersecting vertices of hypotenuse 113 and side 114. In one embodiment, a drill bit 127 is coupled to a winding fork 111 through the sleeve 115. In such an embodiment, the drill bit 127 and the winding fork 111 are coupled through the sleeve as a unitary piece that is installed through a bore 116 in the sleeve 115.

The winding fork 111 comprises two prongs 121 and 122 that extend from a base 162. In use, a user wraps an end of a strap (not shown) around one of the prongs 121 or 122. The user then actuates and rotates the drill bit 127, which causes the winding fork 111 to rotate and wind the strap for storage after use.

Further, the hypotenuse member comprises a notch 161. The notch 161 allows for recessing the base 162 of the winding fork 111. Thus, as will be described further herein, the notch 161 and recessed base 162 allow for an edge 163 of the hypotenuse 113 of the frame 101 to guide a strap (not shown) that is wound by the winding device 111.

Note that actuation of the drill bit 127 may be manual via a handle or automatic via a drill (not shown). Electric and/or battery-powered rotation is shown and described with reference to FIG. 2, whereas manual rotation is shown and described with reference to FIG. 3.

FIG. 2A shows the strap-winding apparatus 100 in use. In this regard, the strap-winding apparatus 100 is coupled to a side wall 290 of a truck bed. In the embodiment depicted, a handle 270 is coupled to the drill bit rod 108. A user of the strap-winding apparatus 100 rotates the handle 270, which in turn rotates the drill bit rod 108 until the drill bit rod 108 applies pressure to the side wall 290 of the truck bed. The pressure applied by the drill bit rod 108 to the side wall 290 retains the strap-winding apparatus 100 in position for use.

A drill 200 is coupled to the retaining shelf 102. In the embodiment shown, the strap 128 which protrudes from the retaining shelf 102, as is described with reference to FIG. 1, wraps over a handle 291 of the drill 200 and around an end of the retaining shelf 102. The strap 128 thus holds the drill 200 in place for use in actuating the winding fork 111. In this regard, a drill chuck 201 of the drill 200 is adapted and arranged to receive the drill bit 127 when the drill 200 is retained on the retaining shelf 102.

In use, an end of a strap 260 is wrapped around one of the prongs 121 or 122. In FIG. 2, the end of the strap 260 is wrapped about prong 122. A user activates the drill 200, which in turn rotates the winding fork 111. As the winding fork 111 rotates, the strap is wound for easier storage after a load has been delivered.

FIG. 2B shows the strap-winding apparatus 100 in use when the strap 260 is substantially wound. As noted herein, the base 162 sits within the recessed notch 161. Thus, as the strap 260 is wound, the edge 163 of the hypotenuse 113 of the frame 101 directs and guides the strap in order to ensure that the strap 260 is would properly.

FIG. 3 depicts a manual embodiment of a strap-winding apparatus 300 in accordance with an embodiment of the present disclosure. The strap-winding apparatus 300 is similar in structure to the strap-winding apparatus 100 depicted in FIG. 1. However, during use, the retaining shelf 102 is rotated to the back of the apparatus 300 as shown to allow a handle 310 to be actuated in winding the strap 260.

In the embodiment depicted in FIG. 3, the strap-winding apparatus 300 further comprises the handle 310. The handle 310 comprises a chuck 311. The handle 310 is fixedly coupled to the drill bit 127 via the chuck 311 such that the handle rotates the drill bit 127, which in turn rotates the winding fork 111. Thus, when a user desires to roll up the strap 260, the user rotates the handle 310. In response, the bit 127 rotates thereby rotating the winding fork 111. As the winding fork 111 rotates, the strap 260 rolls up so that the strap 260 may be more easily stored while not in use.

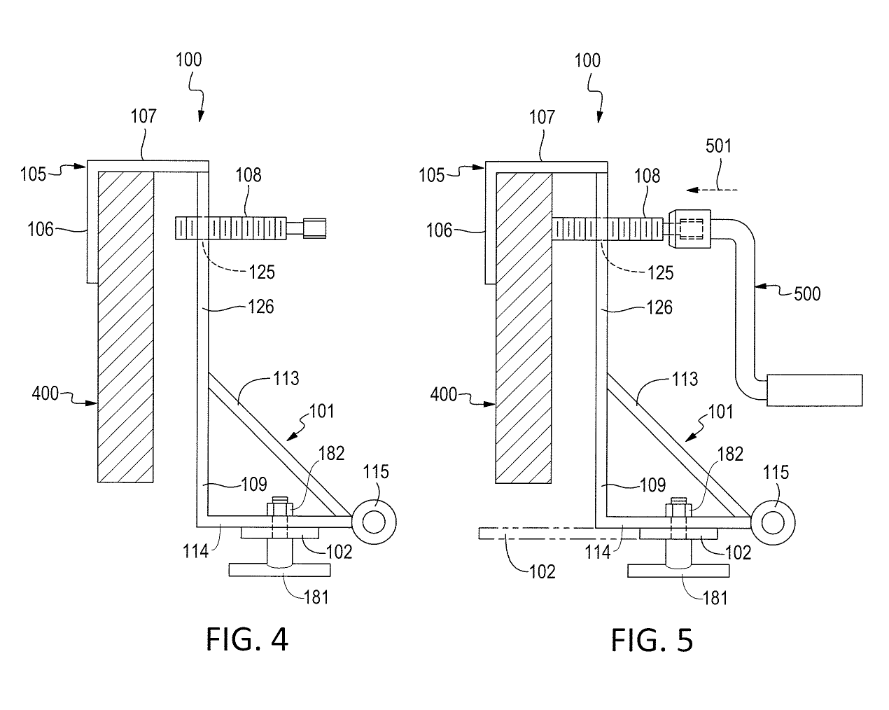

FIGS. 4 and 5 depict the coupling of the strap-winding apparatus 100 (or 300) to a side wall 400 of a truck (not shown). As indicated hereinabove, the vertical plate 106 of the L-shaped coupling member 105 is placed adjacent the vertical plate 106. In this regard, the side wall 400 of the truck is arranged so that it is between the extension arm 126 and the vertical plate 106.

Additionally, FIG. 4 depicts a bolt 182 coupled to the side wall 114. In this regard, the bolt 182 is coupled to the side wall 114 via a threaded T-handle 181. Note that the T-handle 181 may be actuated and rotated to loosen the bolt 182. In this regard, FIG. 4 shows the retaining shelf 102 in a side position extending so that a drill may be coupled to the retaining shelf 102 for actuating the drill bit 127 (FIG. 1).

Further the drill bit rod 108 traverses the opening 125 and protrudes from an opposing face of the extension arm 126. With reference to FIG. 5, a handle 500 is coupled to the drill bit rod 108. As a user (not shown) rotates the handle 500, the rotation induces linear movement in the drill bit rod 108 in a direction indicated by reference arrow 501. When the drill bit rod 108 reaches the side wall 400, it applies pressure to the side wall 400 against the vertical plate 106. The pressure applied by the drill bit rod 108 fixedly retains the strap-winding apparatus 100 (or 300) relative to the side wall 400.

Additionally, FIG. 5 depicts the bolt 182 and the T-handle 181. In this regard, FIG. 5 depicts that the T-handle 181 has been used to loosen the bolt 182. The retaining shelf 102 is shown rotated toward the back so that the handle 310 (FIG. 3) may be used to wind up the strap 260 (FIG. 3).

What is claimed is:

1. A strap-winding apparatus, comprising:
a coupling member fixedly coupled to a frame and adapted for coupling to a stationary object;
a winding device fixedly coupled to the frame and comprising a sleeve, the sleeve adapted for rotatably receiving and retaining a drill bit on a first end and a winding fork on a second end.

2. The strap-winding apparatus of claim 1, further comprising a retaining shelf adapted and arranged for holding a drill in a position such that a drill chuck of the drill receives the drill bit.

3. The strap-winding apparatus of claim 1, further comprising a handle having a chuck, wherein the chuck receives the drill bit.

4. The strap-winding apparatus of claim I, wherein the frame is triangular shaped and the winding device is fixedly coupled to a first intersection of a hypotenuse and a first side of the triangular frame.

5. The strap-winding apparatus of claim 4, wherein a retaining shelf is fixedly coupled to the first side.

6. The strap-winding apparatus of claim 5, wherein a second side extends from an intersection of the hypotenuse and the second side forming an extension arm.

7. The strap-winding apparatus of claim 6, wherein the coupling member comprises a horizontal plate fixedly coupled to a vertical plate in an L-shape.

8. The strap-winding apparatus of claim 7, wherein the extension arm comprises a face through which a threaded bolt extends for coupling to a stationary object.

9. The strap-winding apparatus of claim 1, wherein the frame comprises a notch.

10. The strap-winding apparatus of claim 9, wherein a base of the winding fork fits within the notch.

11. The strap-winding apparatus of claim 10, wherein the frame further comprises an edge adapted and arranged to guide a strap as a strap is being wound on the winding fork.
